(19) United States
(12) Patent Application Publication
(10) Pub. No.: US 2023/0252594 A1
(43) Pub. Date: Aug. 10, 2023

(54) TOUCHPOINT APPARATUS, TOUCHPOINT SYSTEM, TOUCHPOINT METHOD, AND STORAGE MEDIUM

(71) Applicant: NEC Corporation, Minato-ku, Tokyo (JP)

(72) Inventors: Igor OLIVEIRA, Lisbon (PT); Krishna RANGANATH, Roseville, CA (US); Arun CHANDRASEKARAN, Folsom, CA (US); Jason VAN SICE, Arlington, VA (US); Richard WILKS, Witney (GB); Rui Manuel SEQUEIRA, Almada (PT)

(73) Assignee: NEC Corporation, Minato-ku, Tokyo (JP)

(21) Appl. No.: 18/015,650

(22) PCT Filed: Jul. 21, 2021
(86) PCT No.: PCT/JP2021/027407

§ 371 Date: Jan. 11, 2023

Related U.S. Application Data
(60) Provisional application No. 63/054,584, filed on Jul. 21, 2020.

(51) Int. Cl. G06Q 50/30; H04W 4/021; H04W 4/024; G07C 9/25; G06F 21/32; G06F 3/01; G06F 3/16

(52) U.S. Cl. CPC G06Q 50/30; H04W 4/021; H04W 4/024; G07C 9/25; G06F 21/32; G06F 3/017; G06F 3/012; G06F 3/167; G06Q 2240/00

(57) ABSTRACT

A touchpoint system includes a mobile device, a server and an intelligent touchpoint terminal and facilitates a process flow for a user, such as passenger or a visitor, to pass through the facility in a contact-free manner and safe manner.

### TECHNICAL FIELD

The disclosure relates to a touchpoint apparatus, a touchpoint system, a touchpoint method, and a storage medium. More particularly, it relates to a touchpoint apparatus, a touchpoint system, a touchpoint method, and a storage medium for facilitating mobile, interactive and/or contact-free operations in a process flow that can be used in a variety of facilities, such as an airport for example. However, the disclosure is not limited to the process flow in the airport. For instance, one or more aspects of the disclosure may be applied in other facilities or environments.

### RELATED ART

In large facilities, such as mass transit facilities, tourists attractions, amusement parks, etc., a user may be required to go through various procedures to enter or use the facilities. For instance, at an airport, a passenger who intends to board an airplane may be required to go through a process flow involving various procedures such as a check-in procedure, a baggage drop procedure, a security inspection procedure, an immigration procedure, a lounge access procedure or the like, for example, prior to boarding the airplane. In order to facilitate the various procedures in the process flow, touchpoints may be provided at different locations to obtain and process information from the user.

Currently, the world is experiencing a pandemic with the COVID-19 corona virus causing extensive social distancing measures to be taken. With these measures and concern for contracting the virus, there is an urgent and widespread need to limit contact with other people while still engaging in activities that necessitate being in close proximity to strangers. Accordingly, there is a need for users who visit public facilities and follow the required process flows to perform the required procedures with a minimum of contact with publically accessible devices.

### SUMMARY

According to one or more aspects of the disclosure, there is provided a touchpoint apparatus, a touchpoint method, a touchpoint system and a storage medium for facilitating a process flow for a user, such as passenger or a visitor, to pass through the facility in a contact-free manner and safe manner.

According to an aspect of the disclosure, there is provided an apparatus comprising: a memory storing one or more instructions; and a processor configured to execute the one or more instructions to: detect a mobile device entering an area defined by a virtual geographic boundary; receive authentication information from the mobile device upon entered the area; and transmit information related to the area to the mobile device based on verification of the authentication information.

The information related to the area transmitted to the mobile device is an alert or guide information.

The information related to the area transmitted to the mobile device is information corresponding to a stage in a process, among a plurality of stages of the process in an airport, at which apparatus is located.

The information related to the area transmitted to the mobile device is information corresponding to an airline, among a plurality of airlines, selected based on the identification information received from the mobile device.

The information is a common use application replicating an application used by a common use terminal at an airport.

The authentication information is biometric information of a user of the mobile device.

According to another aspect of the disclosure, there is provided a mobile device comprising: a memory storing one or more instructions; and a processor configured to execute the one or more instructions to: determine that the mobile device is entering an area defined by a virtual geographic boundary; enable an application in the mobile device to perform an interaction with an external apparatus based on the determination that the mobile device is entering the area defined by the virtual geographic boundary; transmit authentication information to the external apparatus; and receive information related to the area from the external apparatus based on verification of the authentication information.

The information related to the area transmitted to the mobile device is an alert or guide information.

The information related to the area transmitted to the mobile device is information corresponding a stage in a process, among a plurality of stages in the process in an airport, at which apparatus is located.

The information related to the area transmitted to the mobile device is information corresponding an airline, among a plurality of airlines, selected based on the identification information received from the mobile device.

The information is a common use application replicating an application used by a common use terminal at an airport.

According to another aspect of the disclosure, there is provided an apparatus comprising: a camera; a display; a memory storing one or more instructions; and a processor configured to execute the one or more instructions to: detect a mobile device within an area defined by a virtual geographic boundary; receive identification information from the mobile device; acquire biometric information from an image captured by the camera in the vicinity of the apparatus; and based on a match between the identification information and the biometric information, perform at least one of: transmit to the mobile device information related to the area; display the information related to the area on the display; or establish an interface for performing a touchless interaction with a person associated with the mobile device.

The touchless interaction is an interaction between the person and the apparatus in which the person performs the interaction without touching the apparatus.

The interface is based on gesture control.

The interface is based on voice control.

The interface is based on head control.

The information related to the area transmitted to the mobile device is an alert or guide information.

The information related to the area transmitted to the mobile device is information corresponding a stage in a process, among a plurality of stages in the process in an airport at which apparatus is located.

The information related to the area transmitted to the mobile device is information corresponding to an airline, among a plurality of airlines, selected based on the identification information received from the mobile device.

The apparatus may further comprise a chatbot configured to provide the information related to the area to the user.

The apparatus may further comprise a printer configured to print the information related to the area.

According to another aspect of the disclosure, there is provided an apparatus comprising: a memory storing one or more instructions; and a processor configured to execute the one or more instructions to: detect a mobile device entering an area defined by a virtual geographic boundary; receive identification information from the mobile device; acquire biometric information from an image captured in the vicinity of the apparatus, and transmit information related to the area to the mobile device based on a match between the identification information and the biometric information.

The information related to the area transmitted to the mobile device is an alert or guide information.

The information related to the area transmitted to the mobile device is information corresponding a stage, among a plurality of stages in an airport, at which apparatus is located.

The information related to the area transmitted to the mobile device is information corresponding an airline, among a plurality of airlines, selected based on the identification information received from the mobile device.

The information is a common use application replicating an application used by a common use terminal at the airport.

According to another aspect of the disclosure, there is provided a mobile device comprising: a memory storing one or more instructions; and a processor configured to execute the one or more instructions to: determine that the mobile device is entering an area defined by a virtual geographic boundary; transmit identification information to the external apparatus; and receive information related to the area from the external apparatus based on a match between the identification information and biometric information.

The information related to the area transmitted to the mobile device is an alert or guide information.

The information related to the area transmitted to the mobile device is information corresponding a stage, among a plurality of stages in an airport, at which apparatus is located.

The information related to the area transmitted to the mobile device is information corresponding an airline, among a plurality of airlines, selected based on the identification information received from the mobile device.

The information is a common use application replicating an application used by a common use terminal at the airport.

According to another aspect of the disclosure, there is provided an apparatus comprising: a memory storing one or more instructions; and a processor configured to execute the one or more instructions to: detect a mobile device entering a first area, among a plurality of areas, each designated for a different stage in a passenger flow an airport; receive identification information from the mobile device; acquire biometric information of a user of the mobile device from an image captured in the vicinity of the apparatus; transmit touchpoint user interface related to the first area to the mobile device based on a match between the identification information and the biometric information; receive user input information input by the user through the touchpoint user interface; and perform an airport operation related the first area based on the user input information.

The information related to the first area transmitted to the mobile device is an alert or guide information.

The information related to the first area transmitted to the mobile device is information corresponding a stage, among a plurality of stages in an airport, at which apparatus is located.

The information related to the first area transmitted to the mobile device is information corresponding an airline, among a plurality of airlines, selected based on the identification information received from the mobile device.

The information is a common use application replicating an application used by a common use terminal at the first area at the airport.

### BRIEF DESCRIPTION OF DRAWINGS

FIG. 1A illustrates a process flow for the passengers through the airport.

FIG. 1B illustrates related art technologies used by airports to facilitate the process flow of passengers.

FIG. 2A is a schematic diagram illustrating a configuration of a touchpoint system for facilitating a process flow of a passenger through airport from check-in stage to boarding stage according to an example embodiment.

FIG. 2B is a schematic diagram illustrating a configuration of a touchpoint system for facilitating a process flow of a passenger through airport from check-in stage to boarding stage according to an example embodiment.

FIG. 2C is a schematic diagram illustrating a configuration of a touchpoint system for facilitating a process flow of a passenger through airport from check-in stage to boarding stage according to an example embodiment.

FIG. 3 illustrates geo-fencing according to an example embodiment.

FIG. 4 illustrates sensor fusion according to an example embodiment.

FIG. 5 illustrates proximity detection according to an example embodiment.

FIG. 6A illustrates a process of establishing a mobile interaction according to an example embodiment.

FIG. 6B illustrates a process of establishing a mobile interaction according to an example embodiment.

FIG. 6C illustrates a process of establishing a mobile interaction according to an example embodiment.

FIG. 7 illustrates an interface related to the baggage drop off according to an example embodiment.

FIG. 8A is a diagram illustrating an intelligent touchpoint (ITP) terminal 20 according to an example embodiment.

FIG. 8B is a diagram illustrating an intelligent touchpoint (ITP) terminal 20 according to an example embodiment.

FIG. 9 illustrates a block diagram of the management server 10 according to an example embodiment.

FIG. 10 illustrates a block diagram of the features of the mobile device 80 according to an example embodiment.

FIG. 11 illustrates a block diagram of the features of the ITP terminal 20 according to an example embodiment.

FIG. 12 illustrates a sequence diagram of operations in a touchpoint system according to an example embodiment.

FIG. 13 illustrates a sequence diagram of operations in a touchpoint system according to an example embodiment.

FIG. 14 illustrates a sequence diagram of operations in a touchpoint system according to another example embodiment.

### DESCRIPTION OF EXAMPLE EMBODIMENTS

Example embodiments will now be described below in more detail with reference to the accompanying drawings. The following detailed descriptions are provided to assist the reader in gaining a comprehensive understanding of the methods, apparatuses, and/or systems described herein. However, the example embodiment provided in the disclosure should not be considered as limiting the scope of the disclosure. Accordingly, various changes, modifications, and equivalents of the systems,

apparatuses and/or methods described herein will be suggested to those of ordinary skill in the art.

The terms used in the description are intended to describe embodiments only, and shall by no means be restrictive. Unless clearly used otherwise, expressions in a singular form include a meaning of a plural form. In the present description, an expression such as “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

One or more example embodiments of the disclosure will be described below with reference to the drawings. Throughout the drawings, the same components or corresponding components are labeled with the same reference numerals, and, accordingly, the description thereof may be omitted or simplified.

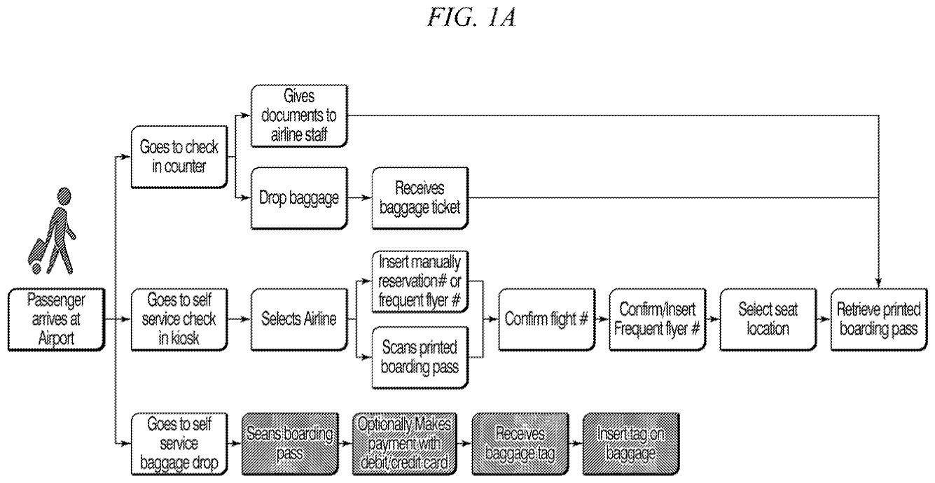

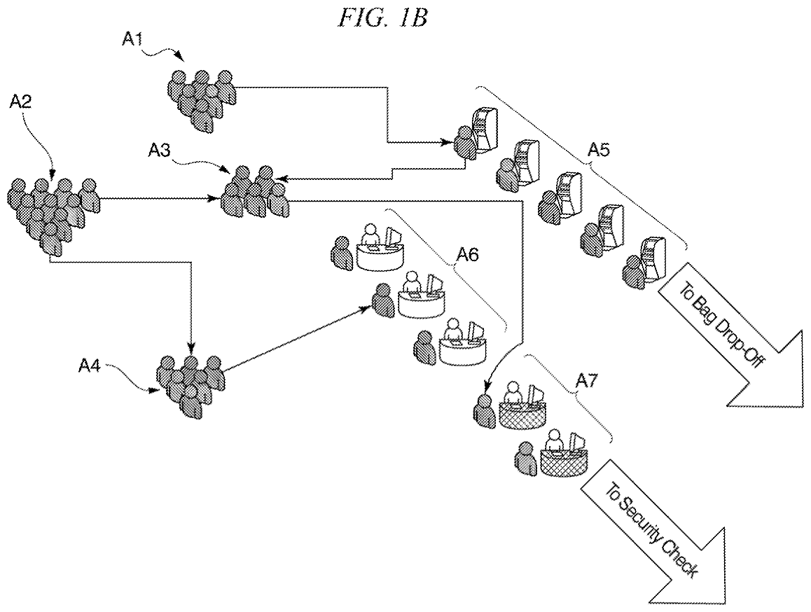

FIG. 1A illustrates a process flow of passengers through the airport and FIG. 1B illustrates related art technologies used by airports to facilitate the process flow of the passengers through the airport. Currently, the airports use Common Use technologies, such as Common Use Terminal Equipment (CUTE), Common Use Self-Service (CUSS) and Common Use Passenger Processing Systems (CUPPS). Generally, the Common Use technologies contain a physical shared device (i.e., check-in kiosks, and computer terminals or workstations at check-in counters, baggage drop off locations and/or boarding areas) which are intended to increase passenger throughput. In FIG. 1B, reference numeral A1 indicates a CUSS kiosk queue. Reference numeral A2 indicates passengers arriving at an airport. Reference numeral A3 indicates passengers in a queue for bag drop-off. Reference numeral A4 indicates passengers in a queue for check-in counters. Reference numeral A5 indicates Common Use Self-Service (CUSS) Kiosks. Reference numeral A6 indicates Common Use Terminal Equipment (CUTE) at check-in counters. Reference numeral A7 indicates Common Use Terminal Equipment (CUTE) at baggage counters.

The CUTE system enables multiple airlines to use and share a same existing airport infrastructure in order to control the passenger and flight processing information into their respective airline applications. For instance, a shared CUTE workstation may launch an airline's host system allowing an agent of the airline to interact directly with the host via touchscreen and/or keyboard interface to process information of a passenger.

The CUSS system is a solution deployed currently in the airports intended to ease and speed up the CUTE process which requires human interactions. For instance, a touchpoint, such as a self-service kiosk, may launch an airline's host system allowing the passenger to interact directly with the host via touchscreen and/or keyboard interface to input and processing information.

As shown in FIG. 1B, passengers arriving at the airport may use the CUTE terminals operated by an agent of the airline at the check-in counters and/or the baggage counters (Reference numeral A6 and A7) or the self-service CUSS kiosks to check-in and process information to board the airplane (Reference numeral A5).

Recently, airlines and airports are not only committed to improving the experience of their passengers and but they also are concerned with protecting the health and safety of the passengers. Specifically, it is important to combat COVID-19 and/or other diseases that are easily spread, especially in public areas, due to lack of social/physical distancing. However, the common use technologies do not provide a touchless/frictionless approach to address such a problem. For instance, as shown in FIGS. 1A and 1B, the CUTE and CUSS touchpoints are available for common use by the traveling public. These common use devices require multiple physical interactions between many different passengers which can increase health concerns for the passengers. To this end, in order to combat the spread of COVID-19 and other communicable diseases, there is a need for touchless and seamless solutions for the process flow at the airport or other similar facilities.

Moreover, the Common Use technologies discussed above, have the following additional drawbacks, such as requiring airport real estate with a large environmental footprint, high infrastructure, energy and hardware costs, dependency on limited number of Common Use providers, lengthy and expensive certifications processes to manage different applications based on different providers. Thus, there is a need for an improved system to ensure that the airport space and real state is used more efficiently and with enhanced process flow that provides more intuitive, clean and secure solutions for the passengers while guaranteeing efficient and cost effective throughput.

In addition, while virtualized solutions running on a cloud network may reduce the need for local datacenters, since physical self-service touchpoints are still required in the above described common use technologies, the above discussed problems remain.

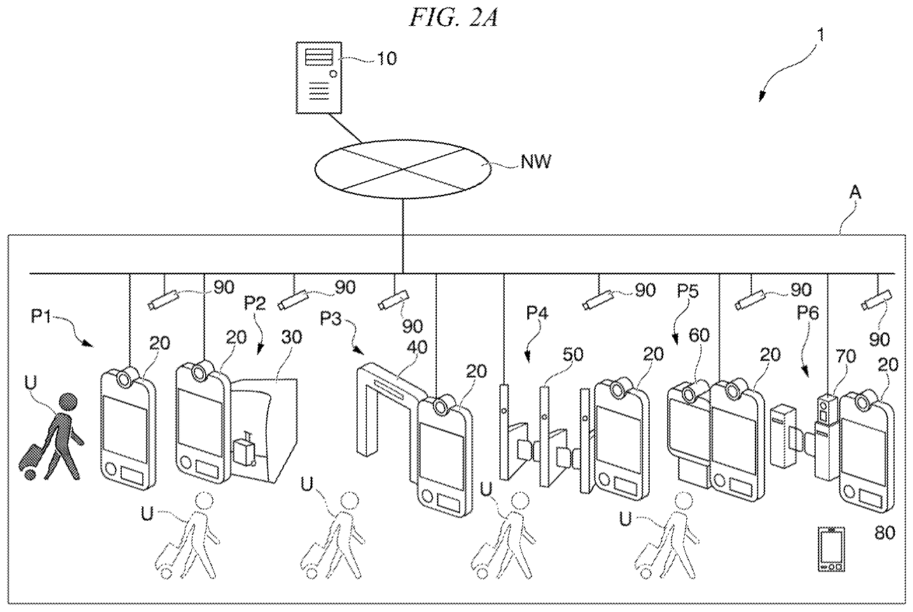

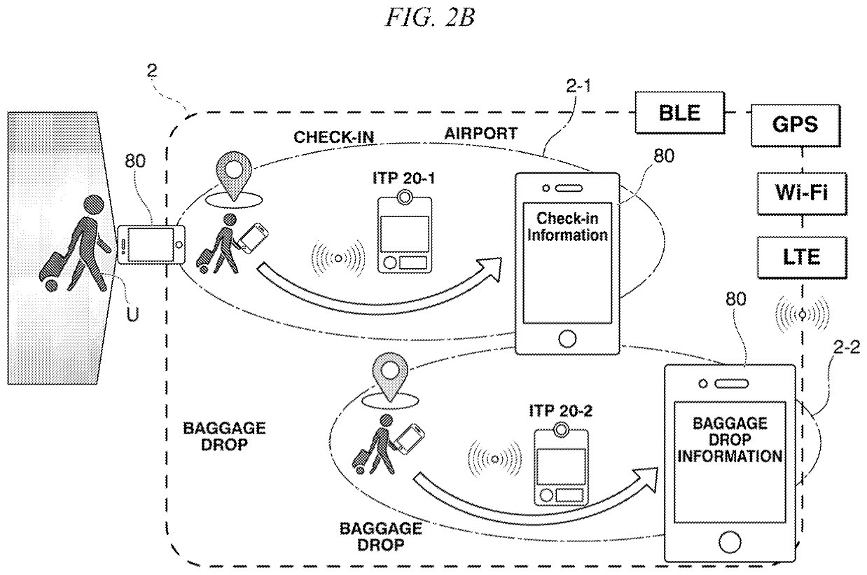

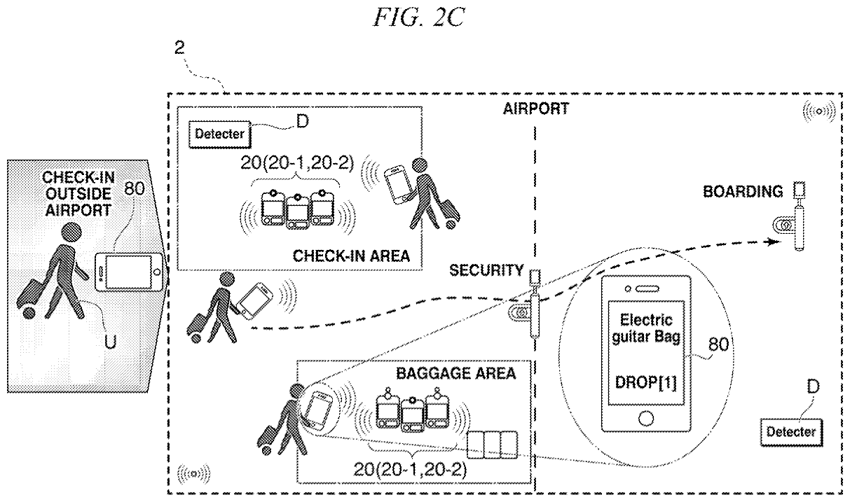

FIG. 2A is a schematic diagram illustrating a configuration of a touchpoint system for facilitating a process flow of a passenger U through an airport from the check-in stage to the boarding stage, according to example embodiment.

As illustrated in FIG. 2A, the touchpoint system 1 according to an example embodiment includes a management server 10, a plurality of intelligent touchpoint (ITP) terminals 20 provided at different areas in a process flow of the passenger U through an airport A, and a mobile device 80. For instance, a plurality of ITP terminals 20 may be provided at a check-in area P1, a baggage drop area P2, a security inspection area P3, an immigration and customs area P4, a signage area P5, and a boarding area P6. Here, the information processing system 1 may recognize and manage the process flow and the status of a passenger U within a facility, such as the airport A, who is scheduled to board an airplane.

According to an example embodiment, the management server 10 may be installed within the airport A. According to another example embodiment, the management server 10 may be installed at a remote location and may be connected to devices and infrastructures in the airport through a network NW. According to an example embodiment, the management server 10 may be implemented based on a cloud technology.

According to an example embodiment, the check-in area P1 may be located in the lobby area P1 within the airport A. Furthermore, an automatic baggage deposit machine may be installed in the baggage counter area P2, a security inspection apparatus 40 may be installed in the security inspection area P3, an automated gate apparatus 50 may be installed in an immigration area P4, a signage terminal 60 may be installed in a passage P5 within the airport A, and a boarding gate apparatus 70 may be installed at the boarding gate area P6. The passage P5 is a passage connected between the immigration area P4 and the boarding gate area P6. The passenger U is able to board an airplane through the boarding gate P6. The mobile device 80 may be a portable electronic device carried by the passenger U. For instance, the mobile device 80 may be a smart phone, a laptop, watch, or other electronic devices that may be carried by the passenger U.

According to an example embodiment, a plurality of surveillance cameras 90 may be installed in respective places within the airport A. The surveillance cameras 90 are installed in the check-in lobby area P1, the baggage counter area P2, the security inspection area P3, the immigration area P4, the passage area P5, and the boarding gate area P6, respectively, for example.

According to an example embodiment, the management server 10, the ITP terminals 20, the automatic baggage deposit machine 30, the security inspection apparatus 40, the automated gate apparatus 50, the signage terminal 60, the boarding gate apparatus 70, and the surveillance cameras 90 are connected to a network NW. Moreover, upon arriving at the airport, the mobile device 80 may be connected to the management server and the ITP terminals 20 through the network NW. The network NW may be configured with a Local Area Network (LAN) including a premise communication network of the airport A, a Wide Area Network (WAN), a mobile communication network, or the like. The mobile device 80 is capable of connecting to the network NW by a wireless scheme.

After arriving at the airport A, the passenger U who is scheduled to board an airplane goes through the check-in lobby area P1, the baggage area P2, the security inspection area P3, the immigration area P4, and the passage P5, and then boards the airplane through the boarding gate area P6. According to an example embodiment, the passenger U may only go through some of the areas, among the check-in lobby area P1, the baggage area P2, the security inspection area P3, the immigration area P4, and the passage P5. For instance, the passenger U may have completed the check-in process at home, or the passenger U may not have any baggage, and therefore the passenger U may have to pass through the check-in lobby area P1 or the baggage area P2. Moreover, according to an example embodiment, the passenger U may be a person scheduled to board an airplane of a domestic flight, and in such a case, the passenger U may skip the immigration area P4.

According to an example embodiment of the disclosure, the touchpoint system 1 provides an improved manner of interaction between the passenger U and the airport process flow using the mobile device 80 of the passenger U and the ITP terminals 20 located at the different areas P1-P6 at the airport. For instance, the improved touchpoint system 1 enables fully contactless and paperless interactions between the passenger U and the airport infrastructures, by facilitating a passenger centric system for standardizing the process flow at the airport using the mobile device 80 and the ITP terminals 20. For instance, according to example embodiments of the disclosure, the mobile device 80 may be used as an interactive device to replicate the user interface, process flow and/or workflows of the existing airport touchpoints such as the CUSS, CUTE and the CUPPS. Moreover, according to example embodiments of the disclosure, there are provided novel ways of detecting a location of a specific user using the mobile device 80 and the ITP terminals 20 and for facilitating an interaction between the passenger U and the ITP terminals 20 and/or the management server 10.

FIG. 2B is a schematic diagram illustrating a specific exemplary configuration of a touchpoint system for facilitating a process flow of a passenger U at the check-in area and the baggage drop off area of the airport.

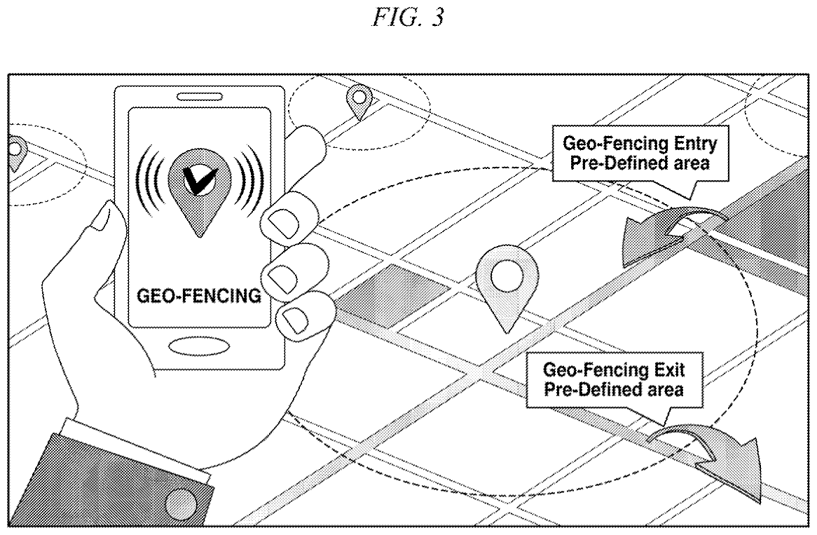

According to FIG. 2B, an area corresponding to the airport A is covered by a geo-fence 2 according to an example embodiment. As illustrated in FIG. 3, a geo-fence represents a virtual boundary around a geographical region, which can be monitored by geo-fencer services. The geo-fence is used to identify when a mobile device 80 of user (i.e., passenger U) that enters or exits the virtual the boundary covered by the geo-fence. When the mobile device 80 of the passenger U crosses the virtual the boundary of the geo-fence, an event/alert may be triggered. According to an example embodiment, the geo-fence may identify the mobile device 80 based on device location detected by a detector D. The detector D may include, but is not limited to, sensors of different technologies, such as GPS, RFID, WIFI, LTE, 5G, BLE, or Beacons, which will enable the software to trigger an interaction when a mobile device 80 enters or leaves a pre-defined area covered by the geo-fence. According to an example embodiment, after detecting the mobile device 80, the system may carry out policies, profiles, restrictions and alerts, etc., corresponding to the particular pre-defined area in which the mobile device 80 is detected.

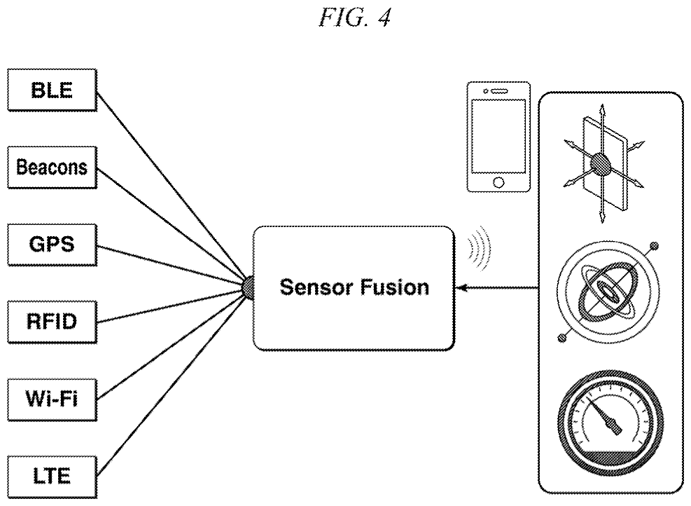

Moreover, in order to improve the accuracy of the detection, sensor fusion may be applied as illustrated in FIG. 4. Sensor fusion gathers data from a plurality of detectors and/or sensors and combines them to improve accuracy of the detection. Furthermore, context-awareness may be used to enable applications to respond intelligently to variable conditions in the sensing devices.

Referring to FIG. 2B, when a mobile device 80 carried by a passenger U enters the geo-fenced region 2, an interaction may be initiated by the geo-fence system. According to an example embodiment, the geo-fence may be monitored by the management server 10. According to another example embodiment, the geo-fence may be monitored by a dedicated geo-fence server or geo-fence systems different from the management server 10 that initiates the interaction between the mobile device 80 and one or more components of the airport infrastructure. For instance, the one or more components of the infrastructure may be the ITP terminals 20 located at different areas (i.e., P1-P6) of the airport. According to another embodiment, the one or more component of the infrastructure may be a geo-fence device or a geo-fence system dedicated to detect a device entering the geo-fence and initiate an interaction with the device.

According to an example embodiment, the interaction may be initiated by waking up an application pre-installed in the mobile device 80. In this case, when the mobile device 80 enters the geo-fenced region 2, the application installed on the mobile device 80 is launched. According to an embodiment, the application may be related to the facility, such as the airport, or the airline. According to an example embodiment, the application may be a common use application, such as CUSS, CUTE, or CUPPS, with the same process, workflow and user interface that is used in a kiosk at the airport. According to another example embodiment, the application may be related to a particular area within the facility, such as the check-in area or the baggage drop off area.

According to another example embodiment, in a case where the application related to the facility is not pre-installed in the device, initiating the interaction may include prompting the user to install the application on the mobile device 80, when the mobile device 80 enters the geo-fenced region 2.

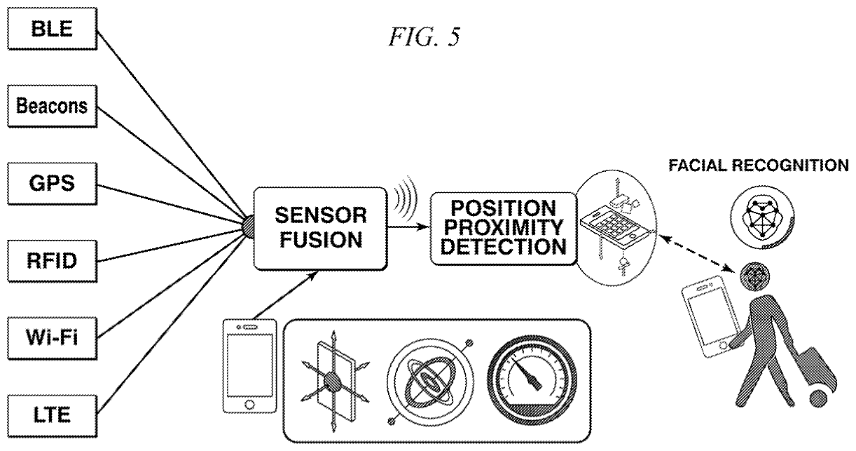

According to an example embodiment, as illustrated in FIG. 2B, a plurality of sub-areas (i.e., 2-1, 2-2 . . . ) within the airport A may be associated with one of the process flow areas, such as check-in P1, baggage P2, etc. When the mobile device 80 enters one of the sub-areas, the ITP terminals 20 may detects the passenger using the application installed on the mobile device 80 through proximity detection technology as illustrated in FIG. 5. According to an example embodiment, the proximity technology may include geo-fence technology or other technologies to sense the location of the mobile device 80. According to an example embodiment, the determination of the location of the passenger U may also be performed using the surveillance cameras 90.

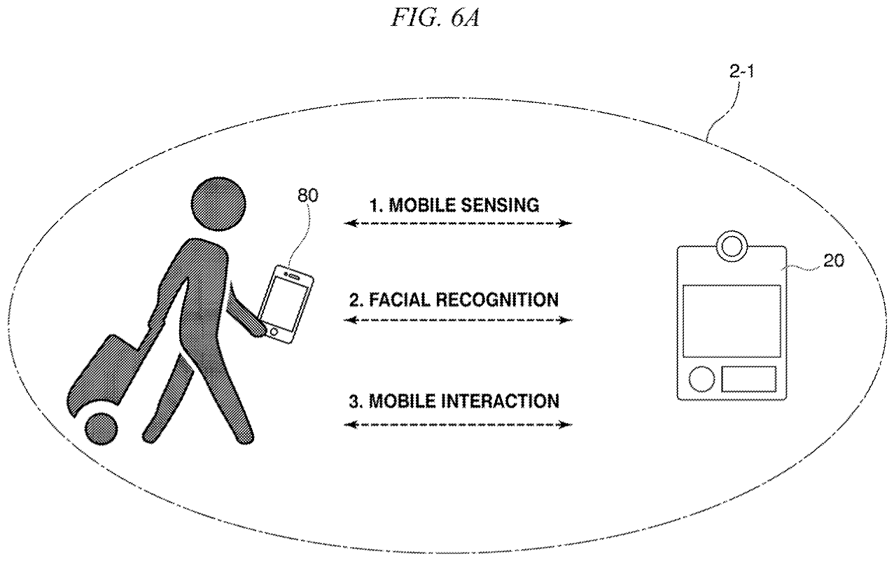

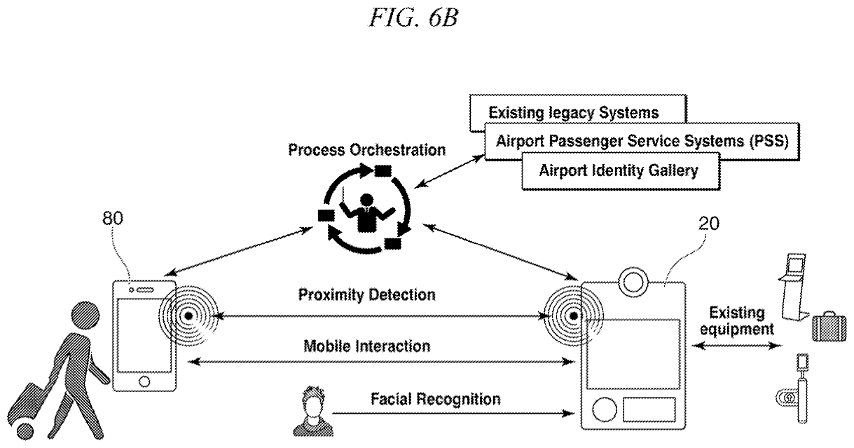

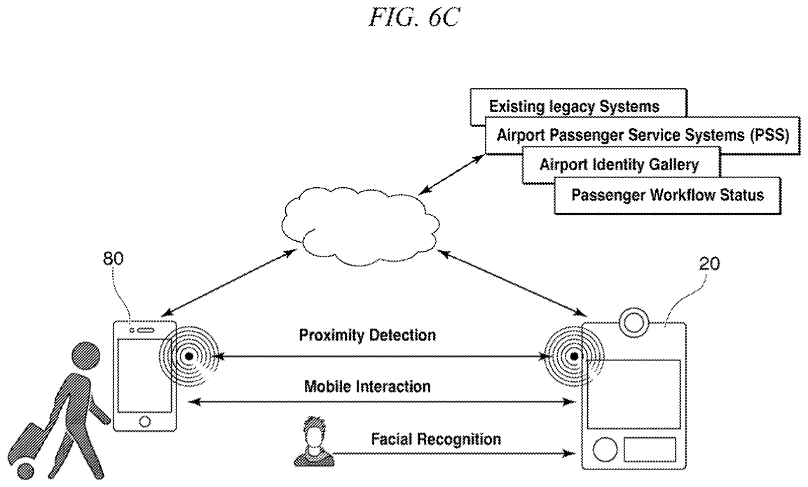

FIG. 6A illustrates a process of establishing a mobile interaction according to an example embodiment. For instance, when an ITP terminal 20 detects the mobile device 80 entering the sub-area 2-1 through a proximity detection technology, the ITP terminal 20 and the mobile device 80 may be associated with each other through an association process. For instance, the ITP terminal 20 may obtain an identification information related to the mobile device 80 and perform a handshake protocol. According to an example embodiment, the ITP terminal 20 may directly perform the handshake protocol with the mobile device 80. According to another example embodiment, the ITP terminal 20 may perform the handshake protocol through an orchestration layer embodied in a server, such as the management server 10.

According to an example embodiment, based on the handshake protocol, a token maybe exchanged between the mobile device 80 and the ITP terminal 20. According to an example embodiment, sensitive information may be stored only in the mobile device 80 in a decentralized way. As such, when the passenger enters sensitive information, a token, i.e., security token, may be created to be shared in the various interactions of the passenger with the infrastructure such as the ITP terminal 20 and the management server 10 of the airport.

According to an example embodiment, the ITP terminal 20 may initiate a facial recognition process to confirm the passenger associated with the mobile device 80 as illustrated in FIG. 5. According to the example embodiment, the facial recognition process is performed after the mobile device 80 is associated with the ITP terminal 20. According to other example embodiments, the facial recognition process may be performed before or simultaneously with the association process for associating the mobile device 80 with the ITP terminal 20. According to other example embodiments, the facial recognition process may include liveness check or other security features.

According to an example embodiment, the facial recognition process may include capturing an image of a person in the vicinity of the ITP terminal 20, and performing a match with a previously stored image associated with the mobile device 80 or the passenger of the mobile device 80. According to another example embodiment, the matching operation may match the captured image with a previously stored image associated with the device information or the token received from the mobile device 80. Accordingly, the passenger is confirmed based on the match between the captured image and a previously stored image.

According to an example embodiment, when the passenger is confirmed, an interface or an application for facilitating an interaction between the mobile device 80 and the ITP terminal 20 may be shared with the mobile device 80. According to an example embodiment, the application may be a common use application, such as CUSS, CUTE, or CUPPS, with the same process, workflow and user interface that is used in a kiosk at the airport. According to an example embodiment, the user interface may provide an alert and guidance information to the passenger for the process flow in the airport.

FIGS. 6B and 6C illustrate processes of establishing a mobile interaction according to other example embodiments. For instance, in FIG. 6B, the interaction between the mobile device 80 and the ITP terminal 20 may be orchestrated by a process orchestration layer at the management server 10. According to another example embodiment, as illustrated in FIG. 6C, the interaction between the mobile device 80 and the ITP terminal 20 may be facilitated by each other by directly accessing necessary information, such as airline data, through the cloud infrastructure.

Referring to FIG. 2B, according to an example embodiment, when the mobile device 80 enters the sub-area 2-1, the ITP 20-1 may associate with the mobile device 80, confirm the passenger U and transmit an interface or an application for facilitating an interaction between the mobile device 80 and the ITP terminal 20-1. According to an example embodiment, an alert may be pushed to mobile device 80 inquiring whether the passenger U would like to perform the check in process. According to another example embodiment, an alert may be pushed to the mobile device 80 inquiring whether the passenger U would like to change information related to a check in that was previously made. In this case, the user may interact with the interface and application provided in the mobile device 80 to complete the check-in process. According to an example embodiment, passenger information will be stored or updated in the system. Moreover, a message may be pushed to the mobile device 80 showing the next destination area for the user.

According to another example embodiment, when the mobile device 80 enters the sub-area 2-1, the ITP 20-1 may associate with the mobile device 80, confirm the passenger U and display information related to the passenger U on a display of the ITP terminal 20-1. Moreover, according to an example embodiment, the ITP terminal 20-1 may transmit an interface or an application for facilitating an interaction between the mobile device 80 and the ITP terminal 20-1. According to an example embodiment, the display information may inquire whether the passenger U would like to change information related to a check in that was previously made. In this case, the passenger U may interact with the ITP terminal 20-1 thorough the interface or the application provided in the mobile device 80 to provide a response to the interactive display information on the display of the ITP terminal 20-1. For instance, a selection in the interface at the mobile device 80 may control a selection displayed on the display of the ITP terminal 20-1. According to another example embodiment, the passenger U may interact with the ITP terminal 20 using gestures or voice control. For instance, the ITP 20-1 may include motion sensors, microphone, and/or camera to detect gestures or audio input by the passenger U.

Referring to FIG. 2B, according to an example embodiment, when the mobile device 80 enters sub-area 2-2, the ITP 20-2 may associate with the mobile device 80, confirm the passenger U and transmit an interface or an application for facilitating an interaction between the mobile device 80 and the ITP terminal 20-2. According to an example embodiment, an alert may be pushed to mobile device 80 inquiring whether the passenger U would like to perform the baggage drop off process. According to another example embodiment, an alert may be pushed to the mobile device 80 inquiring whether the passenger U would like to change information related to a baggage drop off in that was previously made. During the baggage drop off process, if the passenger U selects baggage drop off, the ITP 20-2 may push guidance information to direct the passenger U to the baggage counter 30 to drop of the baggage. Here, the passenger U can interact with the baggage drop ITP terminal 20-2 through the interface on the mobile device 80 or the passenger U can directly interact with the baggage drop ITP terminal 20-2. In the latter case, motion sensors are implemented to detect gestures, such as hang gestures, thumbs up or down and head movements to identify whether the passenger U selects yes or no.

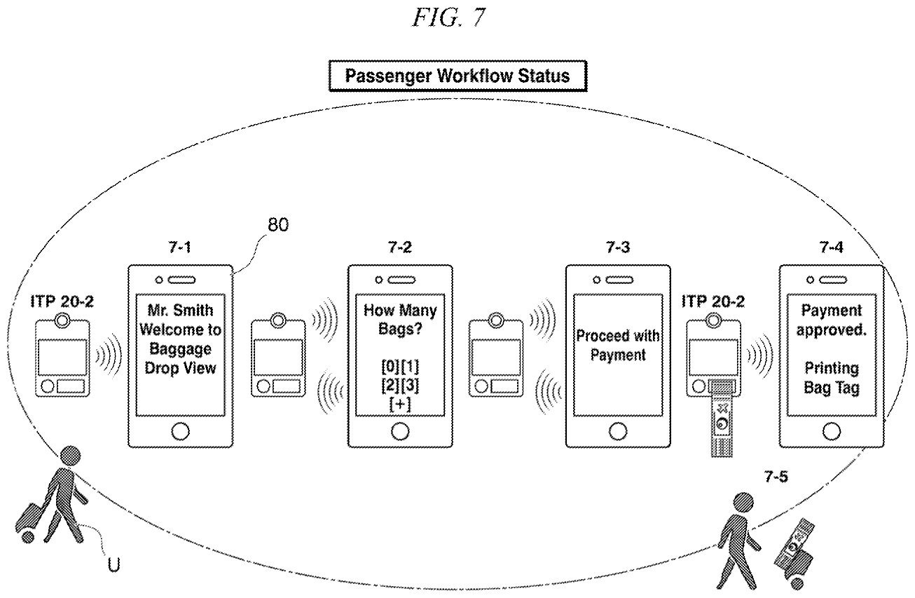

FIG. 7 illustrates an interface related to the baggage drop off according to an example embodiment. In view 7-1, a BagDrop App view is shown. In view 7-2, the passenger U selects a number of bags to drop off. In view 7-3, the passenger U proceeds with payment information. Here, if extra charge is necessary (e.g., i.e., due to the baggage being overweight), a message is pushed to mobile application and passenger U may pay through the application using various electronic payment methods (i.e., credit card or other forms of electronic payment). In view 7-4, the passenger U collects a bag tag printed by the ITP 20-2. In view 7-5, the passenger U attaches the bag tag and drops the baggage at the drop off counter.

According to an example embodiment, regardless of the option used, the graphical presentation/interface may be same on the mobile device 80 and the ITP terminal 20. According to another example embodiment, the graphical presentation/interface may be different on the mobile device 80 and the ITP terminal 20.

According to an example embodiment, if any assistance is needed by the passenger U, the application running on the mobile device 80 of the ITP terminal 20 may provide a chatbot for easy assistance or information to call an airport agent to provide assistance. With proximity information detected by the ITP terminal 20, the airport agent can easily identify the requester and provide the necessary assistance.

In FIG. 2C, a passenger may perform a check-in operation at home (or proper to arriving at the airport) using mobile application related to the airport or the airline installed in the mobile device 80. Here, the passenger may be able to check in directly using mobile phone application where interacting with the application using the same process, workflow and user interface that is used by a common use kiosk at the airport. Moreover, the passenger may also be able to identify the number of baggage to drop off using mobile phone application where interacting with the application using the same process, workflow and user interface that is used by a common use kiosk at the airport.

According to an example embodiment in FIG. 2C, since the passenger has already checked in, the ITP 20-1 may push guide information to the passenger to guide the passenger to the next stage in the work flow. Moreover, since the passenger has already baggage information, the ITP 20-1 may push guide information to guide the passenger to the baggage drop off counter 30.

Although FIGS. 2B and 2C illustrate interactions between the mobile device 80 and the ITP terminals 20-1 and 20-2, respectively at the check in and baggage areas, the disclosure is not limited thereto. According to the novel aspects of the disclosure, the example embodiments include the interactive mobile device 80 that is capable of communicating with other ITP terminals 20 at other areas P3-P5 at the airport that would allow remote interaction between the mobile device 80 and the ITP terminals 20 in order to simplify the complete process.

According to an example embodiment, the touchpoint system of the disclosure may be implemented at a security check point. For instance the ITP terminal 20 at the security check point area P3 may detect a passenger U with mobile application installed on the mobile device 80 through proximity technology. Furthermore, the passenger's face may be validated through face match technology at the ITP terminal 20. If the passenger U is not authorized, the ITP terminal 20 will not allow the doors at the security check point to be opened. A this time, a passenger oriented message is pushed to mobile application of the mobile device 80 showing the problem detected at the security checkpoint and the next steps required to perform. On the other hand, if a passenger U is authorized, the ITP terminal 20 will open doors and allow the passenger U to enter the security zone. Moreover, the passenger information is updated in system records and a message may pushed to mobile application on the mobile device 80 showing where the passenger U should go next. Also, the message may further include information about the distance to next step, due times on ITP terminal 20 and specific sales opportunities on airport stores.

According to an example embodiment, the touchpoint system of the disclosure may be implemented at a lounge area. For instance the ITP terminal 20 at the lounge area may detect a passenger U with mobile application installed on the mobile device 80 through proximity technology. According to an example embodiment, passenger's face may be validated trough face match technology at the ITP terminal 20. If the passenger U is not authorized to enter the lounge a message will be pushed to mobile application on the mobile device 80 explaining the issue. Moreover, specific lounge messages can be pushed to the passenger U regarding lounge information and promotions. Furthermore, if payment is necessary, message may be pushed to mobile application on the mobile device 80, and the passenger U can pay inside the application using various payment methods (i.e., credit card or other electronic devices).

According to an example embodiment, the touchpoint system of the disclosure may be implemented at an immigration area. According to an example embodiment, the touchpoint system can inform immigration authority prior to the arrival of the passenger so more detailed background checks can be done before passenger even reach the touchpoint. In a case that specific questions are need to be answered for emigration purposes this can also be done in the mobile application and shared with emigration authorities even before passenger reaches emigration gates.

According to an example embodiment, the touchpoint system of the disclosure may be implemented at a boarding area. According to an example embodiment, boarding pass information is stored in mobile application of the mobile device 80 and may be shared with airline departure control system (DCS).

Moreover, according to an example embodiment, flight information, gate number, delay and waiting times on queues may also be pushed to the installed application on the mobile device 80 to alert the passenger. According to another example embodiment, the interactive mobile device 80 may also be capable of communicating with existing legacy touchpoint terminals 20 at the airport.

According to another example embodiment, the passenger may use the mobile application to select service to retrieve baggage from home, minimizing interaction and waiting time on the airport. Here, after retrieving the baggage, the system will update information and share baggage ticket in the mobile application. Moreover, if payment is necessary, a message is pushed to mobile application and passenger can pay inside the application using various electronic payment methods.

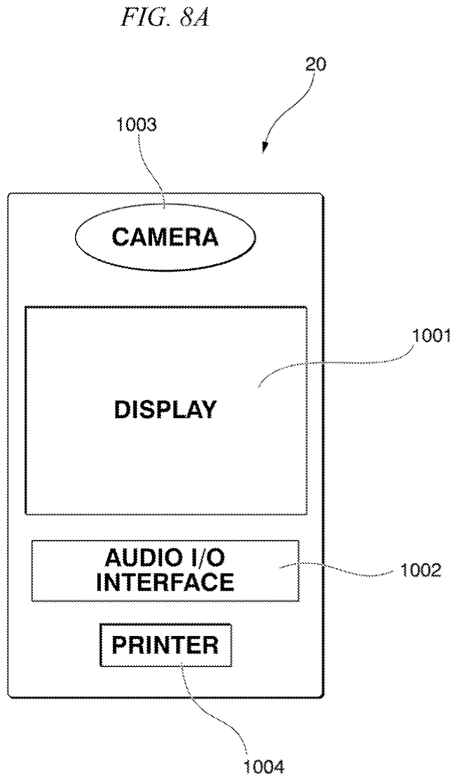

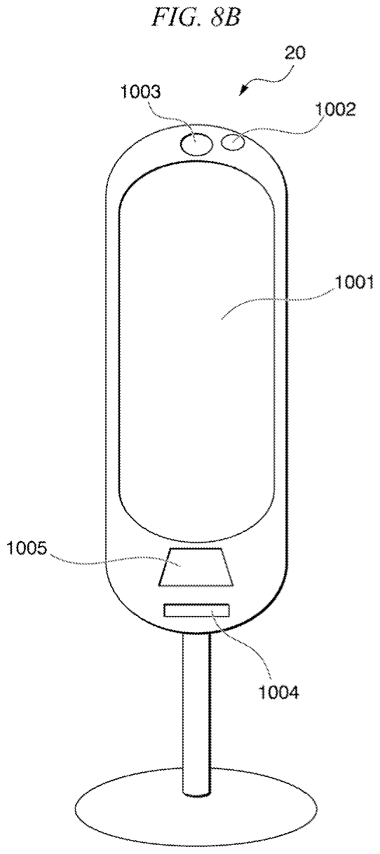

FIGS. 8A and 8B are diagrams illustrating an ITP terminal 20 according to example embodiments. According to an example embodiment, the ITP terminal 20 may include a display 1001, an audio input/output interface 1002, a camera 1003, a memory and a processor. According to some example embodiments, the ITP 20 may include a printer 1004 and a scanner 1005. The audio I/O interface 1002 may be implemented as a chatbot to assist the passenger.

According to an example embodiment, the ITP terminal 20 may be configured to perform proximity detection, recognize gestures performed by users to interact with users, facilitate and perform voice control, facilitate interaction with the mobile device 80 and facilitate interaction with existing airport equipment and infrastructure. According to an example embodiment, the ITP terminal 20 facilitates the interaction with the mobile device 80 by pushing application to the mobile device 80 (touchpoint form factor and workflow to the mobile device 80 of the passenger) and receiving instructions from the mobile device 80 remotely to control the operation of the ITP terminal 20.

According to an example embodiment, a user may be able to control an interface provided through the ITP terminal 20 using head control. For instance, the user may be able to control a selection on a selection screen displayed on the display of the ITP terminal based on a head movement of the user. For example, in response to a selection inquiry, the user may move (or shake) the head left to right or up and down to indicate either yes or no. The type of movement is not limited thereto, and other types of head movement may be used to make selections.

According to an example embodiment, the ITP terminal 20 may inform or advertise that the ITP terminal 20 is capable of being controlled and/or monitored remotely via an external device, such as the mobile device 80. According to an example embodiment, the ITP terminal 20 may inform or advertise an external electronic devices, such as the mobile device 80, that the ITP terminal 20 can be controlled and/or be monitored remotely via an external device, such as the mobile device 80. According to an example embodiment, the ITP terminal 20 not only interfaces and interacts with the mobile device 80 (or another external device), but the ITP terminal 20 also enables an application (i.e., common use application) and one or more functions corresponding to the application based on a workflow available for the passenger to be displayed on the display of the ITP terminal 20. According to an example embodiment, the interface display on the mobile device 80 may be mirrored on the display of the ITP terminal 20. However, the disclosure is not limited thereto.

According to an example embodiment, the ITP terminal 20 may be a static device placed at various locations at a facility. However, the disclosure is not limited thereto, and according to another example embodiment, the ITP terminal 20 may be a non-static device that is mobile. According to an example embodiment, the ITP terminal 20 may have a small form factor and may be used for various purposes. For instance, ITP terminal 20 may have a small form factor that is a common use terminal or kiosks currently used in the airports.

According to another example embodiment, the ITP terminal 20 may be a handheld device that is placed at a counter. According to an example embodiment, an agent of the airline or the facility can pick up or move (using wheels) the non-static ITP device and use it for monitoring purposes and to facilitate the process flow. For instance, according to an example embodiment, the agent may roll or carry the non-static ITP device to approach the passenger and interact with them. According to an example embodiment, in this case, the ITP could assume both a TouchPoint view and an Agent Monitoring tool so the agent can remotely interact with the passenger, while also being able to perform authorized features of the agent monitoring tool, such as manager exceptions, accept flows, etc. According to an example embodiment, the connection between the non-static ITP terminal, other ITP terminal and the passengers mobile device 80 may be performed in the same manner as discussed through geo-fencing and approximation, proximity detection and or facial recognition.

FIG. 9 illustrates a block diagram of the management server 10 according to an example embodiment. For instance, the management server 10 may include a CPU 102, a RAM 104, a storage device 106, and a communication unit 108. The CPU 102, the RAM 104, the storage device 106, and the communication unit 108 are connected to a bus line 110.

The CPU 102 may function as a control unit that operates by executing a program stored in the storage device 106 and controls the operation of the entire management server 10. According to an example embodiment, the CPU 102 may function as an orchestration layer that orchestrates the interactions between the front end components of the touchpoint system, such as the mobile device 80 and the ITP terminal 20, and the backend airport infrastructures, such as gate apparatus and securing check points. Further, the CPU 102 executes an application program stored in the storage device 106 to perform various processes as the management server 10. The RAM 104 provides a memory field necessary for the operation of the CPU 102.

More specifically, the CPU 102 functions as an information management unit that stores user information on the passenger U received from the mobile device 80 and/or the ITP terminal 20 in the storage device 106 and manages the stored user information. The CPU 102 as the information management unit registers user information received from the mobile device 80 and/or the ITP terminal 20 to the user information DB 106a stored in the storage device 106 and manages the registered user information. The CPU 102 registers the received user information to the user information DB 106a every time user information is received from the mobile device 80 and/or the ITP terminal 20. The user information on the passenger U includes identity information, face information, baggage information and boarding information on the passenger U associated with each other. Face information corresponds to a captured face image or a passport face image acquired by the mobile device 80 and/or the ITP terminal 20. A registered face image, which is a captured face image or a passport face image registered in the user information DB 106a, is used for comparison of a face image used for identity verification of the passenger U in the automatic baggage deposit machine 30, the security inspection apparatus 40, the automated gate apparatus 50, and the boarding gate apparatus 70.

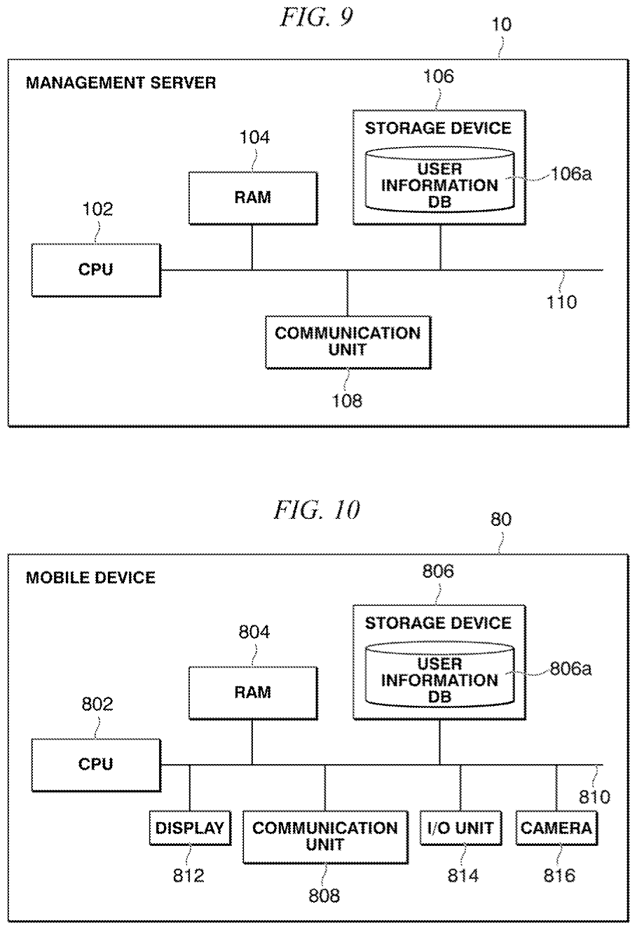

FIG. 10 illustrates a block diagram of the features of the mobile device 80 according to an example embodiment. For instance, the mobile device 80 has a central processing unit (CPU) 802, a random access memory (RAM) 804, a storage device 806, a communication unit 808, a display 812, an input/output (I/O) interface 814 and a camera 816, which may be connected to a bus line 810.

According to an example embodiment, the CPU 802 functions as a control unit that operates by executing a program stored in the storage device 806 and controls the operation of the mobile device 80. Further, the CPU 802 executes an application program stored in the storage device 806 to perform various processes as the mobile device 80. The RAM 804 provides a memory field necessary for the operation of the CPU 802.

According to an example embodiment, the communication unit 808 may include a transceiver configured to transmit and receive data from one or more devices external to the mobile device 80. According to an example embodiment, the communication unit 808 may perform wireless communication. According to an example embodiment, the display 812 may display information. According to an example embodiment, the display 812 may include a touch screen for receiving a touch input. According to an example embodiment, the input/output (I/O) interface 814 may include microphone and speakers to receive audio input and output audio output. According to an example embodiment, the camera 816 may capture one or more images.

According to an example embodiment, the mobile device 80 may act as an enhanced Common Use Terminal Equipment in your pocket. For instance, according to an example embodiment, the mobile device 80 may be able to launch a common use application to initiate and process a workflow similar to a related art CUTE terminal at the airport. In this manner, a user may be able to progress through a work flow at an airport or other facilities, without having to touch kiosks or other terminals located at the airport or other facilities to use and/or interact with the application running on the kiosks or the other terminals. According to an example embodiment, the enhanced “Common Use Terminal Equipment in your pocket” device may include devices that are able to be carried in a pocket of the user. However, the disclosure is not limited thereto, and according to other example embodiments, the enhanced “Common Use Terminal Equipment in your pocket” device may include other electronic portable devices such as laptops, tablets, electronic watches, electronic wearable devices, etc.

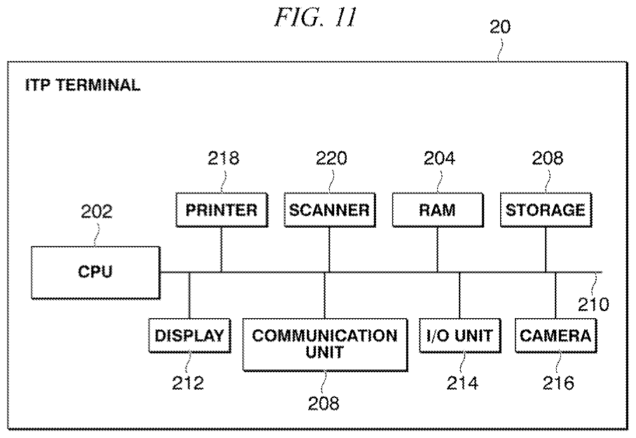

FIG. 11 illustrates a block diagram of the features of the ITP terminal 20 according to an example embodiment. For instance, the ITP terminal 20 has a central processing unit (CPU) 202, a random access memory (RAM) 204, a storage device 206, a communication unit 208, a display 212 and an input/output (I/O) interface 214. Furthermore, the ITP terminal 20 may have a camera 216, a printer 218 and a scanner 220. The CPU 202, the RAM 204, the storage device 206, the communication unit 208, the display 212, the input/output (I/O) interface 214, the camera 214, the printer 216 and the scanner 218 are connected to a bus line 210.

According to an example embodiment, the CPU 202 functions as a control unit that operates by executing a program stored in the storage device 206 and controls the operation of the ITP terminal 20. Further, the CPU 202 executes an application program stored in the storage device 206 to perform various processes as the ITP terminal 20. The RAM 204 provides a memory field necessary for the operation of the CPU 202.

According to an example embodiment, the storage device 206 is formed of a storage medium such as a non-volatile memory, a hard disk drive, or the like and functions as a storage unit. The storage device 206 stores a program executed by the CPU 202, data referenced by the CPU 202 when the program is executed, or the like.

According to an example embodiment, the communication unit 208 may be connected to the network NW and transmits and receives data via the network NW. The communication unit 216 communicates with the management server 10, the mobile device 80 or the like under the control of the CPU 202.

According to an example embodiment, the communication unit 208 may include a transceiver configured to transmit and receive data from one or more devices external to the mobile device 80. According to an example embodiment, the communication unit 208 may perform wireless communication. According to an example embodiment, the display 212 may display information. According to an example embodiment, the input/output (I/O) interface 214 may include microphone and speakers to receive audio input and output audio output. According to an example embodiment, the camera 216 may capture one or more images to perform facial recognition of a passenger. According to an example embodiment, the printer 218 may print boarding passes or bag tags. According to an example embodiment, the scanner 220 may scan documents such as passports. According to an example embodiment, the CPU 202 may be configured to implement an intelligent chatbot to provide assistance to the passenger.

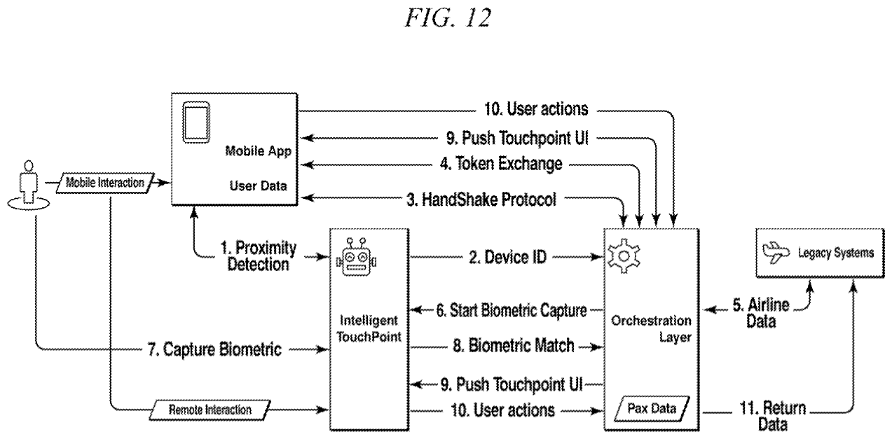

FIG. 12 illustrates a sequence diagram of operations in a touchpoint system according to an example embodiment. The sequence diagram illustrates interactions between a mobile device 80, an ITP terminal 20 and a management apparatus 10 according to an example embodiment.

According to example embodiment, in operation S1, the ITP terminal 20 detects the mobile device 80 entering an area covered by the ITP terminal 20 based on proximity detection. The area may be one of the areas P1-P6 illustrated in FIG. 1. According to an example embodiment, the ITP terminal 20 may use geo-fencing or other forms of proximity detection to detect the mobile device 80. According to an example embodiment, the ITP terminal 20 may obtain an identification information from the mobile device 80 during the proximity detection. The identification information may be a device ID.

In operation S2, the ITP terminal 20 may send the device ID to the management server 10. Based on the received device ID, in operation S3, the management server 10 may initiate a handshake protocol with the mobile device 80. According to another example embodiment, the ITP terminal 20 may initiate the handshake protocol with the mobile device 80 as illustrated in FIG. 6A based on the received device ID. In operation S4, the mobile device 80 exchanges a security token with management server 10 according to an example embodiment. According to another example embodiment, the mobile device 80 may exchange a security token with the ITP terminal 20 as illustrated in FIG. 6A.

In operation S5, the management server may retrieve information related to the security token according to an example embodiment. For instance, the management server may retrieve airline data for the passenger associated with the received security token. According to an example embodiment, the airline data may be retrieved from a database of the legacy infrastructures storing passenger and airline data.

In operation S6, the management server 10 may send a request to the ITP terminal to obtain biometric information of the user of mobile device 80. In operation S7, the ITP terminal 20 may obtain biometric information of the user of mobile device 80. According to another example embodiment, the ITP terminal 20 may obtain the biometric information of the user without receiving a request from the management server 10. According to an example embodiment, the biometric information may be a facial image of the user captured by a camera of the ITP terminal 20.

In operation S8, the ITP terminal 20 may send the captured facial image to the management apparatus 10 for biometric matching. The management server 20 may perform facial recognition to match the facial image receive from the ITP terminal 20 by comparing the captured facial image with a previously registered image associated with the obtained security token. The previously registered image may be stored in the database as part of the airline data.

In operation S9, the management server 10 may push touchpoint user interface (UI) to the mobile device 80 and the ITP terminal 20. According to an example embodiment, the same touchpoint UI may be transmitted to both the mobile device 80 and the ITP terminal 20.

In operation S10, the mobile device 80, interacts directly to the management server 10 or remotely controls the user interface provided on the ITP terminal 20. For instance, the user may operate on the mobile device 80 to enter information related to the process flow at the area in which the ITP terminal 20 is located. According to an example embodiment, the information entered by the user at the mobile device 80 is directly transmitted to the management server 10. According to an example embodiment, the information entered by the user at the mobile device 80 may control selections on the touchpoint UI provided at the ITP terminal 20, which may be forwarded to the management server 10. According to another example embodiment, the user may use gestures to control selections on the touchpoint UI provided at the ITP terminal instead of the mobile device 80.

In operation S11, the management server 10 may obtain and process the information entered by the user and update the database of the airline infrastructure.

According to an example embodiment, a plurality of mobile devices may be able to simultaneously interact with the management server 20 based on a biometric match after the proximity detection and the capture of biometric information by the ITP terminal 20. According to an example embodiment, the plurality of mobile devices may directly interact with the management server 20 at the same time after the touchpoint user interface is pushed onto the mobile device 80. According to another example embodiment, the touchpoint UI may be transmitted only to the mobile device 80.

According to another example embodiment, the mobile device 80 may be configured not only to be used to remotely control the ITP terminal 20, but the mobile device 80 may be implemented as standalone touchpoint devices that eliminate the dependency on physical terminals altogether. For instance, the passenger would, in effect, have a touchpoint in the pocket, which is as an intelligent Passenger Processing Mobile Device, the passenger may be able to use whenever necessary without having to depend on physical Common Use terminals.

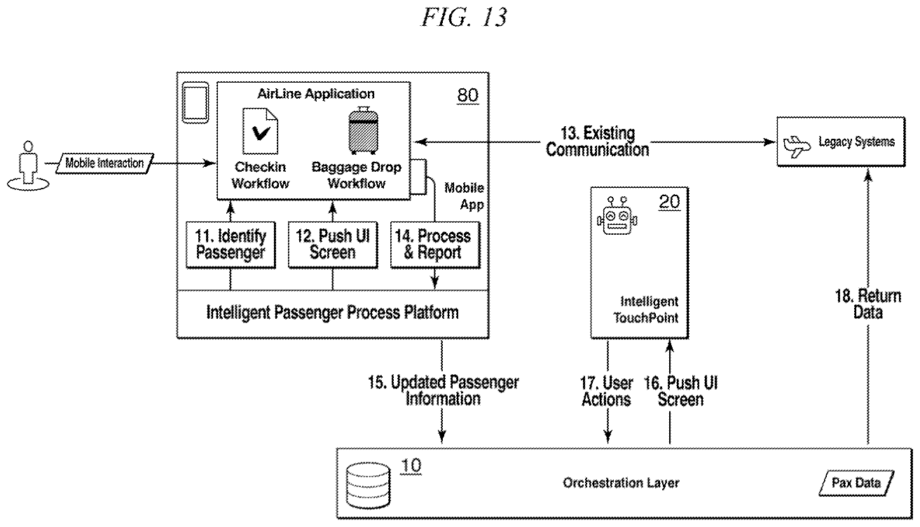

FIG. 13 illustrates a sequence diagram of operations in a touchpoint system according to an example embodiment. The sequence diagram illustrates interactions between a mobile device 80 and a management apparatus 10 according to an example embodiment.

According to an example embodiment, a mobile application may be installed on the mobile device 80 to facilitate a platform for allowing passengers to execute their workflows on the mobile device 80 based on the passenger's flight information as illustrated in FIG. 13. According to an example embodiment, the platform may be an intelligent passenger process platform, that would act as a market place where the airlines can host and publish their specific Airline Application (i.e., Airline APP Lite), which can be launched via the mobile device 80. Moreover, according to an example embodiment, the pending tasks that are not completed on the platform may be delegated to the ITP terminals 20 at the airport, which will complete the task at the airport.

According to an example embodiment, in operation S11, the mobile application running on the mobile device 80 identifies a passenger. For instance, the mobile application may identify flight information related to the passenger. In operation S12, the mobile application may launch a user interface screen related to one of the workflows for boarding an airplane. For instance, the mobile application may launch an UI screen related to a check-in workflow. According to another example embodiment, the mobile application may launch an UI screen related to a baggage drop workflow.

In operation S13, the mobile application may communicate with infrastructure of the legacy system to access and retrieve data. For instance, the mobile application may communicate with a database of the legacy systems to access and retrieve data necessary to complete the workflows. According to an example embodiment, the access to the legacy systems or other operations of the mobile application may be allowed only after authentication of the user of the mobile device 80.

In operation S14, the information entered by the user of the mobile device 80 is processed and reported to a management server 10. The management server 10 may include an orchestration layer for managing and updating the passenger information received from the mobile application running on the mobile device 80 as illustrated in operation S15.

According to another example embodiment, the information entered by the user of the mobile device 80 is processed and reported directly to the legacy systems. For instance, the database of the airline may be updated with the information entered by the user of the mobile device 80.

In operation S16, based on the status of the workflow, the orchestration layer of the management server 10 may push an UI screen onto an ITP terminal 20. For instance, the pending tasks that are not completed on the platform may be delegated to the ITP terminals 20 at the airport, which will complete the task at the airport. In operation S17, user actions corresponding to the UI screen are received by the orchestration layer of the managing server 10. In operation S18, the orchestration layer updates the passenger data and transmits to the infrastructure of the legacy systems.

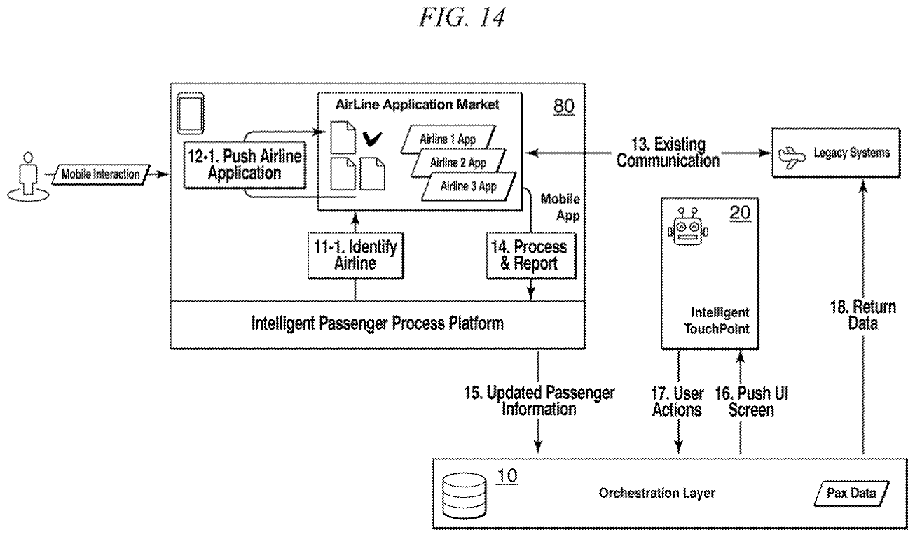

FIG. 14 illustrates a sequence diagram of operations in a touchpoint system according to another example embodiment. For instance, FIG. 14 illustrates another example embodiment, in which, the mobile device 80 would launch an existing airline application. For instance, in operation S11-1, the mobile application identifies an airline and in operation S12-1, the mobile application launches the airline application. After the airline application is launched, the operations performed by the mobile device 80 may be similar to the operations illustrated in FIG. 13.

The disclosure is not limited to the example embodiments described above but can be changed as appropriate within a range not departing from the spirit of the disclosure. For instance, although the example embodiments illustrate the ITP terminal, the mobile device and the management server being used in an airport for facilitating various workflow procedures necessary for a user to enter or use the airport, the disclosure is not limited thereto. For instance, according to another example embodiment, the ITP terminal, the mobile device and/or the management server may be used in any facility, such as mass transit facilities, tourist attractions, amusement parks, museums, supermarkets etc., which utilize touchpoint devices to assist a user with the service provided the facility.

The scope of one or more example embodiments also includes a processing method of storing, in a storage medium, a program that causes the configuration of the example embodiment to operate to implement the function of the example embodiment described above, reading out as a code the program stored in the storage medium, and executing the code in a computer. That is, a computer readable storage medium is also included in the scope of each example embodiment. Further, not only the storage medium in which the program described above is stored but also the program itself is included in each example embodiment. Further, one or more components included in the example embodiments described above may be a circuit such as an Application Specific Integrated Circuit (ASIC), a Field Programmable Gate Array (FPGA), or the like configured to implement the function of each component.

As the storage medium, for example, a floppy (registered trademark) disk, a hard disk, an optical disk, a magneto-optical disk, a Compact Disk (CD)-ROM, a magnetic tape, a nonvolatile memory card, or a ROM can be used. Further, the scope of each of the example embodiments includes an example that operates on Operating System (OS) to perform a process in cooperation with another software or a function of an add-in board without being limited to an example that performs a process by an individual program stored in the storage medium.

The service implemented by the function of one or more example embodiments described above can be provided to the user in a form of Software as a Service (SaaS).

Note that all the example embodiments described above are mere examples of embodiments in implementing the disclosure, and the technical scope of the disclosure should not be construed in a limiting sense by these example embodiments. That is, the disclosure can be implemented in various forms without departing from the technical concept thereof or the primary feature thereof.

The whole or part of the example embodiments disclosed above can be described as, but not limited to, the following supplementary notes.

(Supplementary Note 1)

An Apparatus Comprising:

a memory storing one or more instructions; and

a processor configured to execute the one or more instructions to:
detect a mobile device entering an area defined by a virtual geographic boundary;
receive authentication information from the mobile device upon entered the area; and
transmit information related to the area to the mobile device based on verification of the authentication information,

wherein the information indicates that the apparatus is capable of being controlled or monitored remotely via the mobile device.

(Supplementary Note 2)

The apparatus of supplementary note 1, wherein the information related to the area transmitted to the mobile device is an alert or guide information.

(Supplementary Note 3)

The apparatus of supplementary note 1, wherein the information related to the area transmitted to the mobile device is information corresponding to a stage in a process, among a plurality of stages of the process in an airport, at which apparatus is located.

(Supplementary Note 4)

The apparatus of supplementary note 1, wherein the information related to the area transmitted to the mobile device is information corresponding to an airline, among a plurality of airlines, selected based on the identification information received from the mobile device.

(Supplementary Note 5)

The apparatus of supplementary note 1, wherein the information is a common use application replicating an application used by a common use terminal at an airport.

(Supplementary Note 6)

The apparatus of supplementary note 1, wherein the authentication information is biometric information of a user of the mobile device.

(Supplementary Note 7)

A mobile device comprising:

a memory storing one or more instructions; and

a processor configured to execute the one or more instructions to:
determine that the mobile device is entering an area defined by a virtual geographic boundary;
enable an application in the mobile device to perform an interaction with an external apparatus based on the determination that the mobile device is entering the area defined by the virtual geographic boundary;
transmit authentication information to the external apparatus; and
receive information related to the area from the external apparatus based on verification of the authentication information.

(Supplementary Note 8)

The mobile device of supplementary note 7, wherein the information related to the area transmitted to the mobile device is an alert or guide information.

(Supplementary Note 9)

The mobile device of supplementary note 7, wherein the information related to the area transmitted to the mobile device is information corresponding a stage in a process, among a plurality of stages in the process in an airport, at which apparatus is located.

(Supplementary Note 10)

The mobile device of supplementary note 7, wherein the information related to the area transmitted to the mobile device is information corresponding an airline, among a plurality of airlines, selected based on the identification information received from the mobile device.

(Supplementary Note 11)

The mobile device of supplementary note 7, wherein the information is a common use application replicating an application used by a common use terminal at an airport.

(Supplementary Note 12)

The mobile device of supplementary note 7, wherein the mobile device is configured to act as an enhanced Common Use Terminal Equipment in your pocket.

(Supplementary Note 13)

The mobile device of supplementary note 7, wherein the processor is further configured to execute common use applications.

(Supplementary Note 14)

An Apparatus Comprising:

a camera;

a display;

a memory storing one or more instructions; and

a processor configured to execute the one or more instructions to:
detect a mobile device within an area defined by a virtual geographic boundary;
receive identification information from the mobile device;
acquire biometric information from an image captured by the camera in the vicinity of the apparatus; and
based on a match between the identification information and the biometric information, perform at least one of:
transmit to the mobile device first information related to the area;
display, on the display of the apparatus, second information related to the area to enable an application and one or more functions corresponding to the application based on a workflow available for the passenger; or
establish an interface for performing a touchless interaction with a person associated with the mobile device.

(Supplementary Note 15)

The apparatus of supplementary note 14, wherein the touchless interaction is an interaction between the person and the apparatus in which the person performs the interaction without touching the apparatus.

(Supplementary Note 16)

The apparatus of supplementary note 14, wherein the interface is based on gesture control.

(Supplementary Note 17)

The apparatus of supplementary note 14, wherein the interface is based on voice control.

(Supplementary Note 18)

The apparatus of supplementary note 14, wherein the interface is based on head control.

(Supplementary Note 19)

The apparatus of supplementary note 14, wherein the first information related to the area transmitted to the mobile device is an alert or guide information.

(Supplementary Note 20)

The apparatus of supplementary note 14, wherein the interface is based on a remote control of the apparatus using a mobile device by a user.

(Supplementary Note 21)

The apparatus of supplementary note 14, wherein the first information related to the area transmitted to the mobile device is information corresponding a stage in a process, among a plurality of stages in the process in an airport at which apparatus is located.

(Supplementary Note 22)

The apparatus of supplementary note 14, wherein the first information related to the area transmitted to the mobile device is information corresponding to an airline, among a plurality of airlines, selected based on the identification information received from the mobile device.

(Supplementary Note 23)

The apparatus of supplementary note 14, further comprising:

a chatbot configured to provide the first information related to the area to the user.

(Supplementary Note 24)

The apparatus of supplementary note 14, further comprising:

a printer configured to print the first information related to the area.

(Supplementary Note 25)

The apparatus of supplementary note 14, wherein the apparatus is one of:

a handheld device, or

a device having a small form factor that is a common use terminal at an airport.

(Supplementary Note 26)

The apparatus of supplementary note 14, wherein the apparatus is a non-static movable device configured to facilitate interaction with the passenger, monitor a process flow or monitor other apparatus, intelligent touchpoint terminals or mobiles devices.

(Supplementary Note 27)

The apparatus of supplementary note 14, wherein the first information and the second information are the same.

(Supplementary Note 28)

An Apparatus Comprising:

a memory storing one or more instructions; and

a processor configured to execute the one or more instructions to:
detect a mobile device entering an area defined by a virtual geographic boundary;
receive identification information from the mobile device;
acquire biometric information from an image captured in the vicinity of the apparatus, and
transmit information related to the area to the mobile device based on a match between the identification information and the biometric information.

(Supplementary Note 29)

The apparatus of supplementary note 28, wherein the information related to the area transmitted to the mobile device is an alert or guide information.

(Supplementary Note 30)

The apparatus of supplementary note 28, wherein the information related to the area transmitted to the mobile device is information corresponding a stage, among a plurality of stages in an airport, at which apparatus is located.

(Supplementary Note 31)

The apparatus of supplementary note 28, wherein the information related to the area transmitted to the mobile device is information corresponding an airline, among a plurality of airlines, selected based on the identification information received from the mobile device.

(Supplementary Note 32)

The apparatus of supplementary note 28, wherein the information is a common use application replicating an application used by common use terminal at the airport.

(Supplementary Note 33)

A mobile device comprising:

a memory storing one or more instructions; and

a processor configured to execute the one or more instructions to:
determine that the mobile device is entering an area defined by a virtual geographic boundary;
transmit identification information to the external apparatus; and
receive information related to the area from the external apparatus based on a match between the identification information and biometric information.

(Supplementary Note 34)

The mobile device of supplementary note 33, wherein the information related to the area transmitted to the mobile device is an alert or guide information.

(Supplementary Note 35)

The mobile device of supplementary note 33, wherein the information related to the area transmitted to the mobile device is information corresponding a stage, among a plurality of stages in an airport, at which apparatus is located.

(Supplementary Note 36)

The mobile device of supplementary note 33, wherein the information related to the area transmitted to the mobile device is information corresponding an airline, among a plurality of airlines, selected based on the identification information received from the mobile device.

(Supplementary Note 37)

The mobile device of supplementary note 33, wherein the information is a common use application replicating an application used by common use terminal at the airport.

(Supplementary Note 38)

An Apparatus Comprising:

a memory storing one or more instructions; and

a processor configured to execute the one or more instructions to:
detect a mobile device entering a first area, among a plurality of areas, each designated for a different stage in a passenger flow an airport;
receive identification information from the mobile device;
acquire biometric information of a user of the mobile device from an image captured in the vicinity of the apparatus;
transmit touchpoint user interface related to the first area to the mobile device based on a match between the identification information and the biometric information;
receive user input information input by the user through the touchpoint user interface; and
perform an airport operation related the first area based on the user input information.

(Supplementary Note 39)

The apparatus of supplementary note 38, wherein the information related to the first area transmitted to the mobile device is an alert or guide information.

(Supplementary Note 40)

The apparatus of supplementary note 38, wherein the information related to the first area transmitted to the mobile device is information corresponding a stage, among a plurality of stages in an airport, at which apparatus is located.

(Supplementary Note 41)

The apparatus of supplementary note 38, wherein the information related to the first area transmitted to the mobile device is information corresponding an airline, among a plurality of airlines, selected based on the identification information received from the mobile device.

(Supplementary Note 42)

The apparatus of supplementary note 38, wherein the information is a common use application replicating an application used by common use terminal at the first area at the airport.

This application is based upon and claims the benefit of priority from U.S. provisional patent application No. 63/054,584 filed on Jul. 21, 2020, the disclosure of which is incorporated herein in its entirety by reference.

What is claimed is:

1. An apparatus comprising:
a memory storing one or more instructions; and
a processor configured to execute the one or more instructions to:
detect a mobile device entering an area defined by a virtual geographic boundary;
receive authentication information from the mobile device upon entered the area; and
transmit information related to the area to the mobile device based on verification of the authentication information,
wherein the information indicates that the apparatus is capable of being controlled or monitored remotely via the mobile device.

2. The apparatus of claim 1, wherein the information related to the area transmitted to the mobile device is an alert or guide information.

3. The apparatus of claim 1, wherein the information related to the area transmitted to the mobile device is information corresponding to a stage in a process, among a plurality of stages of the process in an airport, at which apparatus is located.

4. The apparatus of claim 1, wherein the information related to the area transmitted to the mobile device is information corresponding to an airline, among a plurality of airlines, selected based on the identification information received from the mobile device.

5. The apparatus of claim 1, wherein the information is a common use application replicating an application used by a common use terminal at an airport.

6. The apparatus of claim 1, wherein the authentication information is biometric information of a user of the mobile device.

7. A mobile device comprising:
a memory storing one or more instructions; and
a processor configured to execute the one or more instructions to:
determine that the mobile device is entering an area defined by a virtual geographic boundary;
enable an application in the mobile device to perform an interaction with an external apparatus based on the determination that the mobile device is entering the area defined by the virtual geographic boundary;
transmit authentication information to the external apparatus; and
receive information related to the area from the external apparatus based on verification of the authentication information.

8. The mobile device of claim 7, wherein the information related to the area transmitted to the mobile device is an alert or guide information.

9. The mobile device of claim 7, wherein the information related to the area transmitted to the mobile device is information corresponding a stage in a process, among a plurality of stages in the process in an airport, at which apparatus is located.

10. The mobile device of claim 7, wherein the information related to the area transmitted to the mobile device is information corresponding an airline, among a plurality of airlines, selected based on the identification information received from the mobile device.

11. The mobile device of claim 7, wherein the information is a common use application replicating an application used by a common use terminal at an airport.

12. The mobile device of claim 7, wherein the mobile device is configured to act as an enhanced Common Use Terminal Equipment in your pocket

13. The mobile device of claim 7, wherein the processor is further configured to execute common use applications.

14. An apparatus comprising:
a camera;
a display;
a memory storing one or more instructions; and
a processor configured to execute the one or more instructions to:
detect a mobile device within an area defined by a virtual geographic boundary;
receive identification information from the mobile device;
acquire biometric information from an image captured by the camera in the vicinity of the apparatus; and
based on a match between the identification information and the biometric information, perform at least one of:
transmit to the mobile device first information related to the area;
display, on the display of the apparatus, second information related to the area to enable an application and one or more functions corresponding to the application based on a workflow available for the passenger; or
establish an interface for performing a touchless interaction with a person associated with the mobile device.

15. The apparatus of claim 14, wherein the touchless interaction is an interaction between the person and the apparatus in which the person performs the interaction without touching the apparatus.

16. The apparatus of claim 14, wherein the interface is based on gesture control.

17. The apparatus of claim 14, wherein the interface is based on voice control.

18. The apparatus of claim 14, wherein the interface is based on head control.

19. The apparatus of claim 14, wherein the first information related to the area transmitted to the mobile device is an alert or guide information.

20. The apparatus of claim 14, wherein the interface is based on a remote control of the apparatus using a mobile device by a user.

21.-42. (canceled)
